(19) United States
(12) Patent Application Publication
(10) Pub. No.: US 2024/0051022 A1
(43) Pub. Date: Feb. 15, 2024

(54) CONDUCTIVE METAL PARTICLE PRODUCTION METHOD

(71) Applicant: PROTERIAL, LTD., Tokyo (JP)

(72) Inventor: Hidehito MORI, Osaka (JP)

(73) Assignee: PROTERIAL, LTD., Tokyo (JP)

(21) Appl. No.: 18/259,669

(22) PCT Filed: Mar. 23, 2022
(86) PCT No.: PCT/JP2022/013732

§ 371 Date: Jun. 28, 2023

(30) Foreign Application Priority Data
Mar. 30, 2021 (JP) 2021-056511

(51) Int. Cl. B22F 9/24

(52) U.S. Cl. CPC B22F 9/24; B22F 2301/15; B22F 2301/10

(57) ABSTRACT

A method for producing conductive metal particles. The method includes: mixing a first aqueous solution containing Ni and NaOH with a second aqueous solution containing P to prepare a third aqueous solution with a pH greater than 7; and inducing a reductive deposition reaction in the third aqueous solution to produce Ni-based conductive metal materials, in which the median diameter (d50) of the conductive metal particles is regulated by adjusting the concentration of NaOH in the third aqueous solution.

### TECHNICAL FIELD

The present invention relates to a method for producing conductive metal particles and conductive metal particles, and more particularly to a method for producing reduction-precipitation type Ni-based conductive metal particles and conductive metal particles.

### BACKGROUND ART

A reductive deposition type Ni-based conductive metal particle and a method for producing the same are known. For example, Patent Literature 1 discloses a reduction-precipitation type Ni-based conductive metal particle containing 1 to 15 mass % of P (phosphorus) and 0.01 to 18 mass % of Cu, and a method for producing the same. Patent Literature 2 discloses a reduction-precipitation type Ni-based conductive metal particle containing 1 to 15 mass % of P, 0.01 to 18 mass % of Cu, and 0.05 to 10 mass % of Sn (tin), and a method for producing the same.

The reduction-precipitation type Ni based conductive metal particles (hereinafter referred to as NiP particles) disclosed in Patent Documents 1 and 2 have advantages of small volume resistivities and good conductivities. Further, in the reductive deposition reaction to generate the NiP particles, nuclei for growing into NiP particles (hereinafter referred to as “nuclei of NiP”) are generated at an initial stage of the reaction; and the nuclei of NiP grow to a predetermined particle size in the subsequent reaction to form NiP particles having a predetermined median diameter. Therefore, if the growth of NiP nuclei is appropriately controlled, it is possible to produce NiP particles of 10 μm or less, for example, with good sphericity. Here, with regard to the size reduction of the NiP particles, Patent Document 1 discloses that the sizes of the NiP particles deposited by reduction tend to become smaller and the variation in the sizes of the NiP particles tends to become smaller as the molar ratio (Ni/Cu) of Ni ions to Cu ions increases in an aqueous solution for reductive deposition of NiP particles containing Ni salt or the like containing Cu ions. Patent Document 2 discloses that the sizes of the NiP particles deposited by reduction tend to become smaller and the variation in the size of the NiP particles tends to become smaller as the molar ratio (Ni/Sn) of Ni ions to Sn ions decreases in an aqueous solution for reductive deposition of NiP particles, the aqueous solution containing a Ni salt or the like containing Cu ions and Sn ions. The size of the NiP particles is understood as the median diameter (d50) in the particle size distribution curve. The variation in the size of the NiP particles is understood as the dispersion ((d90−d10)/d50) in the particle size distribution curve. The smaller the dispersion is, the sharper the particle size distribution can be obtained.

For conductive metal particles such as NiP particles, realization of smaller particles and stabilization of supply are required in a wide range of applications such as: anisotropic conductive film (ACF); paste-like materials such as anisotropic conductive paste (ACP) and anisotropic conductive adhesive (ACAs); and connection methods for flex-on-board (FOB) and flex-on-flex (FOF), in accordance with the recent desire for further miniaturization and higher definition of electronic communication devices.

### CITATION LIST

### Patent Literature

Patent Literature 1: Japanese Patent No. 5622127
Patent Literature 2: Japanese Patent No. 5327582

### SUMMARY OF INVENTION

### Technical Problem

In the methods for preparing conductive particles according to Patent Literature 1 and Patent Literature 2, a classification process must be interposed in order to reduce the dispersion of NiP particles, which is time-consuming. In addition, an expensive reagent must be used in order to reduce the median diameter, which excessively increases the manufacturing cost. Therefore, there is room for improvement.

An object of the present invention is to provide is a simple and inexpensive method for adjusting the median diameter of conductive metal particles (NiP particles).

### Solution to Problem

In the method for producing NiP particles disclosed in Patent Literatures 1 and 2, the inventor of the present invention examined various aspects of the configurations of various aqueous solutions used for reductive deposition of NiP particles, reductive deposition conditions, and the like. The inventor found that there exists a relatively strong correlation between the median diameter of NiP particles and the concentration of NaOH in the aqueous solution in which the reductive deposition reaction occurs, which has not been known in the prior art. Then, it was confirmed that the median diameter of the NiP particles can be adjusted by the concentration of NaOH in the aqueous solution in which the reductive deposition reaction occurs, and that the above-mentioned problem can be solved. Thus, the present invention was conceived.

Disclosed is a method for producing conductive metal particles, the method including: mixing a first aqueous solution containing Ni (Ni ion) and NaOH with a second aqueous solution containing P (hypophosphite ion) to prepare a third aqueous solution with a pH greater than 7, and inducing a reductive deposition reaction in the third aqueous solution to produce Ni-based conductive metal particles, in which the median diameter of the conductive metal particles is regulated by adjusting the concentration of NaOH in the third aqueous solution.

In the production of the conductive metal particles described above, the concentration of NaOH in the third aqueous solution is preferably adjusted so that the median diameter of the conductive metal particles is regulated to 10 μm or less.

In the production of the conductive metal particles, preferably, the concentration of NaOH in the third aqueous solution is adjusted so that the dispersion of the conductive metal particles is adjusted to 1.0 or less.

In the case where the size of the conductive metal particles is reduced by the invention of the manufacturing method in which the first aqueous solution contains Ni (Ni ions), the concentration of NaOH in the third aqueous solution is preferably adjusted to 0.190 mol/L or more and 0.230 mol/L or less.

In the invention of the manufacturing method in which the first aqueous solution contains Ni (Ni ion), the first aqueous solution preferably contains Cu (Cu ion).

In the invention of the manufacturing method in which the first aqueous solution contains Ni (Ni ion), the first aqueous solution preferably contains Sn (Sn ion).

In the invention of the manufacturing method containing Ni (Ni ion), Cu (Cu ion) and Sn (Sn ion) in the first aqueous solution, the molar ratio of Sn to Cu (Sn/Cu) in the third aqueous solution is preferably adjusted to be less than 5.5.

### Advantageous Effects of Invention

The present invention includes a simple method for preparing conductive metal particles (NiP particles) having a median diameter selected from the range of 1.0 μm to 10 μm, for example, and the dispersion of 1.0 or less, for example. Thus, the conductive metal particles having a median diameter selected from a range of 1.0 μm to 10 μm, for example, can be supplied inexpensively and stably.

### BRIEF DESCRIPTION OF DRAWINGS

FIG. 1 is a graph showing the relationship between the concentration of NaOH in the third aqueous solution and d50 of the obtained NiP particles (NiP particle group), which is an experimental result.

FIG. 2 is a graph showing the relationship between the concentration of NaOH in the third aqueous solution and the dispersion of the obtained NiP particles (NiP particle group), which is an experimental result.

FIG. 3 is an example of an observation image (photograph) of NiP particles (NiP particle group) based on Ni and containing P.

FIG. 4 is an example of an observation image (photograph) of No. 5 NiP particles (NiP particle group) based on Ni and containing P and Cu.

FIG. 5 is an example of an observation image (photograph) of No. 3 NiP particles (NiP particle group), which are representative NiP particles (NiP particle group) based on Ni and containing P, Cu and Sn.

### DESCRIPTION OF EMBODIMENT

Hereinafter, a method for producing conductive metal particles and conductive metal particles according to the present invention will be described in detail. It should be understood that the configuration of the method for producing the conductive metal particles and the configuration of the conductive metal particles according to the present invention are indicated by the claims, and include all modifications within the meaning and scope equivalent to the claims. Further, in the following description and drawings, the term “particle” may be used both when one particle (a single particle) is intended and when a group of particles (particle group) is intended. However, the term “single particle” or “group of particles” may be used only when it is particularly limited. In addition, “Ni (Ni ion)”, “P (hypophosphite ion)”, “Cu (Cu ion)” and “Sn (Sn ion)” relating to the aqueous solution may be expressed as “Ni”, “P”, “Cu” and “Sn” respectively for convenience.

Further, the “median diameter” according to the present invention means a median diameter which can be obtained based on a cumulative volume distribution curve, and is expressed as “d50”. Further, the dispersion according to the present invention is intended to be a value of (d90−d10)/d50 using d50, d10 and d90 which can be obtained based on the cumulative volume distribution curve. A group of particles with small dispersion shows a sharp particle size distribution. The values of d10, d50 (median diameter), and d90 indicate particle diameters when the cumulative volume in the cumulative volume distribution curve of the particle group becomes 10%, 50%, and 90%, respectively. It should be noted that the cumulative volume distribution curve is intended to be obtained by a measuring apparatus employing a laser diffraction scattering method unless otherwise specified.

### <Production Method of Conductive Metal Particles>

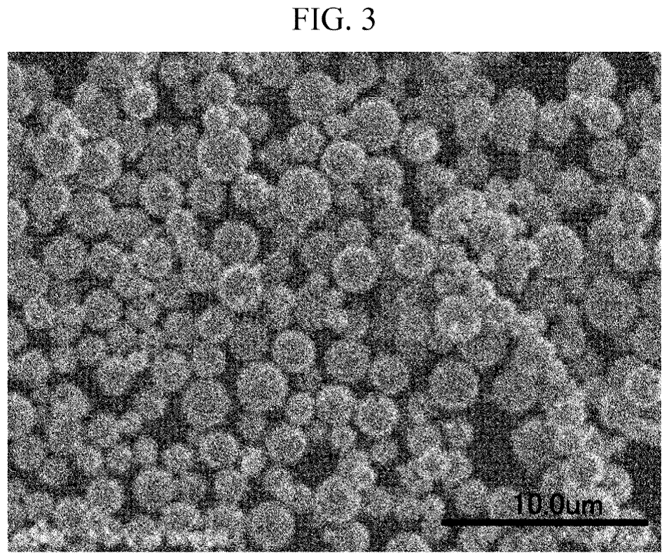

Disclosed is a method for producing conductive metal particles, including: mixing a first aqueous solution containing Ni (Ni ions) and NaOH with a second aqueous solution containing P (hypophosphite ions) to prepare a third aqueous solution with a pH greater than 7; and inducing a reductive deposition reaction in the third aqueous solution to produce Ni-based conductive metal particles. Further, the median diameter of the conductive metal particles is adjusted by adjusting the concentration of NaOH in the third aqueous solution. By this production method, conductive metal particles (NiP particles) based on Ni and containing P can be produced. For example, NiP particles based on Ni and containing P can be produced by adjusting the concentration of NaOH in a third aqueous solution containing Ni and P. An example of NiP particles in this case is shown in FIG. 3. When an appropriate amount of P is contained in the third aqueous solution, the surface of the obtained NiP particles tends to become hard, so that the effect of improving the mechanical strength of the NiP particles can be expected.

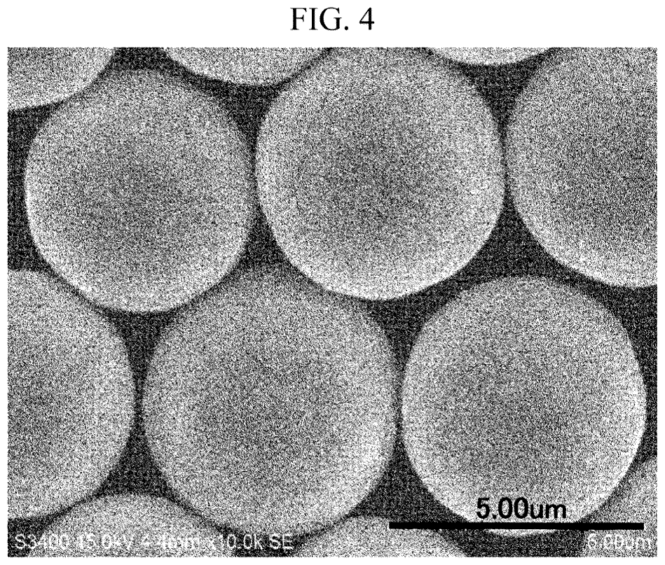

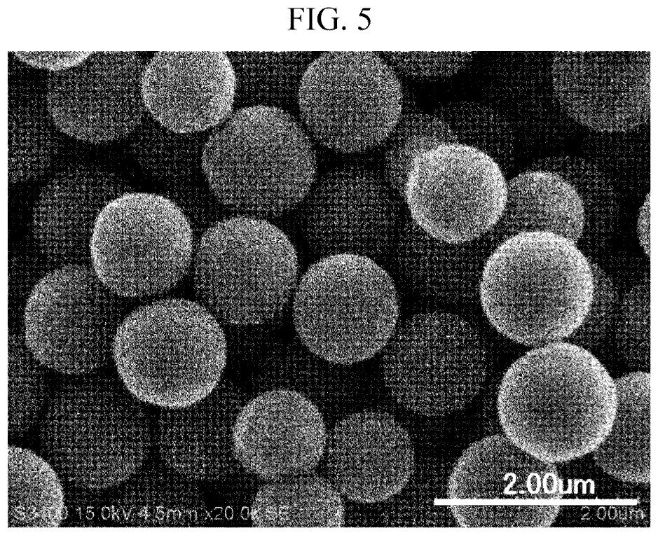

In the manufacturing method according to the present invention, the first aqueous solution preferably contains Cu (Cu ion). Thus, NiP particles based on Ni and containing P and Cu can be produced having d50 corresponding to the concentration of NaOH in the third aqueous solution containing Ni, P, and Cu. An example of NiP particles in this case is shown in FIG. 4. When an appropriate amount of Cu is contained in the third aqueous solution, the conductivity of the obtained NiP particles tends to increase, so that an effect of improving the conductivity of the NiP particles can be expected. Further, when an appropriate amount of Cu is contained in the third aqueous solution, the dispersion of the obtained NiP particles tends to be suppressed to be small.

In the production method according to the present invention, the first aqueous solution preferably contains Sn (Sn ion). Thus, NiP particles based on Ni and containing P and Sn can be produced having d50 corresponding to the concentration of NaOH in the third aqueous solution containing Ni, P, and Sn. When an appropriate amount of Sn is contained in the third aqueous solution, the obtained NiP particles tend to have a smaller d50 value, so that the effect of making the NiP particles smaller can be expected. Further, when an appropriate amount of Sn is contained in the third aqueous solution, the dispersion of the obtained NiP particles tends to be suppressed to be small.

In the manufacturing method according to the present invention, the first aqueous solution more preferably contains Cu (Cu ion) and Sn (Sn ion). Thus, NiP particles based on Ni and containing P, Cu and Sn can be produced having d50 corresponding to the concentration of NaOH in the third aqueous solution containing Ni, P, Cu and Sn. An example of NiP particles in this case is shown in FIG. 5. When an appropriate amount of Cu and Sn is contained in the third aqueous solution, the d50 and the dispersion of the obtained NiP particles tend to become more stable, so that an effect of further stabilizing the reduction of the size of the NiP particles can be expected.

In the present invention, the step of inducing a reductive deposition reaction in the third aqueous solution to produce Ni-based conductive metal particles uses an electroless reduction method. Hereinafter, this process is referred to as “granulation process”. For the detailed description of the reductive deposition reaction (electroless reduction method) induced in the third aqueous solution, refer to the knowledge of Patent Literatures 1 and 2.

By the way, based on the knowledge of Patent Literatures 1 and 2, the inventor of the present invention examined a simple method for regulating the median diameter of NiP particles and desirably explored a simple method for preparing NiP particles having a predetermined median diameter and exhibiting a sharp particle size distribution for the purpose of realizing technically more stable reduction in size of NiP particles and stabilizing supply of NiP particles.

As the first experiment, an experiment was carried out to increase the molar ratio Ni/Cu in the aqueous solution at the start of reductive deposition. Following aqueous solutions were prepared: 7 dm³ of an aqueous solution of nickel sulfate hexahydrate (hereinafter referred to as solution A); 0.5 dm³ of an aqueous solution of copper sulfate pentahydrate (hereinafter referred to as solution B); 3 dm³ of an aqueous solution of sodium tin trihydrate (hereinafter referred to as solution C); 15 dm³ of pH-adjusted aqueous solution, 3.5 dm³ of pH buffer aqueous solution; and 16 dm³ of the reducing agent aqueous solution. Solution A is an aqueous solution using nickel sulfate hexahydrate and containing nickel (Ni ion) with a pH of 5.3 and a concentration of nickel sulfate hexahydrate of 1.03 mol/L. Solution B is an aqueous solution using copper sulfate pentahydrate and containing Cu (Cu ion) with a pH of 3.6 and a concentration of copper sulfate pentahydrate of 0.43 mol/L. Solution C is an aqueous solution using sodium stannate trihydrate and containing Sn (Sn ion) with a pH of 12.0 and a concentration of 0.55 mol/L of sodium stannate trihydrate. The pH-adjusted aqueous solution is an aqueous solution using NaOH with a pH of 13 and concentration of NaOH of 0.685 mol/L. This pH-adjusted aqueous solution is added in accordance with the disclosure of Patent Literatures 1 and 2 that the aqueous solution at the start of reductive deposition is adjusted to an alkaline solution with a pH greater than 7. The pH buffer aqueous solution is an aqueous solution using sodium acetate with a pH of 9.0 and a concentration of sodium acetate of 4.29 mol/L. The reducing agent aqueous solution is an aqueous solution using sodium hypophosphite monohydrate and containing P (hypophosphite ion) with a pH of 6.2 and a concentration of sodium hypophosphite monohydrate of 1.8 mol/L.

Next, a solution A, a solution B, a solution C, a pH-adjusted aqueous solution and a pH buffer aqueous solution were mixed to prepare 29 dm³ of mixed aqueous solution containing Ni (Ni ion), Cu (Cu ion) and Sn (Sn ion) with an alkaline pH of 9.3. Then, 29 dm³ of the mixed aqueous solution was maintained at a temperature of about 60° C. while stirring with bubbling nitrogen gas in the reaction vessel, and 16 dm³ of reducing agent aqueous solution maintained at a temperature of about 60° C. in the same condition was mixed to the 29 dm³ of the mixed aqueous solution to start reductive deposition. At the beginning of the reductive deposition, the aqueous solution in the stirring tank exhibited an alkaline pH of 9.3. As a result of this first experiment, although the median diameter of the NiP particles was reduced, the dispersion of the NiP particles was increased unlike the description of Patent Literature 1. In order to obtain NiP particles having a sharp particle size distribution by reducing the dispersion of the NiP particles, the classification process is repeated many times. However, since the yield of the NiP particles is greatly reduced as the man-hour for classifying the NiP particles increases, the manufacturing cost becomes excessively high, and other problems occur.

In addition, as a second experiment, an experiment was conducted to decrease the molar ratio Ni/Sn in the aqueous solution at the start of reductive deposition. Following aqueous solutions were prepared: 7 dm³ of solution A as in the first experiment; 0.5 dm³ of solution B with a higher concentration than in the first experiment (concentration 0.58 mol/L, pH 3.7); 3 dm³ of solution C with a lower concentration than in the first experiment (concentration 0.50 mol/L, pH 12.0); 15 dm³ of the pH-adjusted aqueous solution as in the first experiment; 3.5 dm³ of the pH buffer aqueous solution as in the first experiment; and 16 dm³ of the reducing agent aqueous solution as in the first experiment.

Next, a solution A, a solution B, a solution C, a pH-adjusted aqueous solution and a pH buffer aqueous solution were mixed to prepare 29 dm³ of mixed aqueous solution containing Ni (Ni ion), Cu (Cu ion) and Sn (Sn ion) and exhibiting an alkaline pH of 9.3. Then, 29 dm³ of the mixed aqueous solution was maintained at a temperature of about 60° C. while stirring with bubbling nitrogen gas in the reaction vessel, and 16 dm³ of reducing agent aqueous solution maintained at a temperature of about 60° C. in the same condition was mixed to the 29 dm³ of the mixed aqueous solution to start reductive deposition. At the beginning of the reductive deposition, the aqueous solution in the stirring tank exhibited an alkaline pH of 9.3. As a result of this second experiment, reducing the median diameter of NiP particles was succeeded. However, reagents such as copper sulfate pentahydrate and sodium stannate trihydrate are relatively expensive. Therefore, the preparation method using an expensive reagent causes disadvantages such as excessively high production cost.

Unlike Patent Literatures 1 and 2, in the present invention, the concentration of NaOH in the third aqueous solution is important in the granulation step, not the concentration of NaOH in the first aqueous solution. Conventionally, the work (operation) itself of preparing various components constituting the first aqueous solution and the second aqueous solution respectively within a predetermined range and the control (operation) itself of the liquid temperature of the third aqueous solution for inducing the reductive deposition reaction have been easy and simple operations. Therefore, as disclosed in Patent Literatures 1 and 2, the adjustment of d50 and dispersion of NiP particles has been performed mainly by adjusting the concentration of Ni contained in the first aqueous solution and controlling the liquid temperature of the third aqueous solution within a narrow range (for example, 70±1° C., see Patent Literatures 1 and 2). When the first aqueous solution contains either Cu or Sn, or contains both Cu and Sn, the concentration of Cu with respect to Ni (molar ratio Ni/Cu) and/or the concentration of Sn with respect to Ni (molar ratio Ni/Sn) are adjusted in addition to the concentration of Ni and the solution temperature.

In such a conventional preparation method, as disclosed in Patent Literatures 1 and 2, the concentration of NaOH in the first aqueous solution is adjusted for the purpose of making the third aqueous solution alkaline (pH>7) for inducing the reductive deposition reaction. For example, Patent Literatures 1 and 2 define adjusting the pH at the start of the reductive deposition to be alkaline, more than 7 (refer to the claims), and specifically disclose the pH of the mixed aqueous solution (corresponding to the first aqueous solution in the present invention) in the examples. However, the pH of the aqueous solution (corresponding to the third aqueous solution in the present invention) at the start of the reductive deposition is not disclosed. Further, Patent Literatures 1 and 2 do not describe or suggest the purpose of adjusting the pH of the aqueous solution (corresponding to the third aqueous solution in the present invention) at the start of reductive deposition other than making the aqueous solution at the start of reductive deposition alkaline (pH>7). Therefore, adjusting the pH of the first aqueous solution to be more than 7 at the start of reductive deposition disclosed in Patent Literatures 1 and 2 is the same as adjusting the pH of the first aqueous solution to be more than 7 in the present invention. Further, adjusting the pH at the start of reductive deposition to an alkaline value of more than 7 as disclosed in Patent Literatures 1 and 2 and adjusting the pH of the third aqueous solution in the present invention are not synonymous.

That is, in the conventional adjustment method, it is sufficient as long as the aqueous solution at the start of reductive deposition is at least alkaline (pH>7), and the concentration of NaOH which makes the first aqueous solution alkaline is usually adjusted to a relatively high concentration.

The inventor found a relatively strong correlation between the d50 of the NiP particles and the concentration of NaOH in the third aqueous solution. The inventor has come up with the method of the present invention in which the d50 of the NiP particles is adjusted by the “concentration of NaOH of the third aqueous solution” which has not been taken seriously so far.

In this invention, since the concentration of NaOH in the third aqueous solution is higher, the d50 of the NiP particles can be made smaller. Since the concentration of NaOH is higher, the generation amount (number) of the nuclei of NiP generated in the initial stage of the reductive deposition reaction can be increased when the reductive deposition reaction is induced in the third aqueous solution. The concentration of Ni (Ni ion) in the third aqueous solution decreases as the nuclei of NiP formed at the initial stage of the reductive deposition reaction grow. The decrease in the concentration of Ni (Ni ion) proceeds faster as the amount (number) of generated NiP nuclei increases. Therefore, as the number of NiP nuclei increases, the absolute amount of Ni (Ni ion) contributing to the growth of each NiP nucleus, that is, the formation of each NiP particle is reduced, and the sizes (d50) of the NiP particles finally obtained are suppressed to be small.

Based on an approximate analytical knowledge (quadratic approximation formula) obtained by experiments, for example, when the concentration of NaOH in the third aqueous solution is 0.19 mol/L or more (0.23 mol/L or less), the d50 of the NiP particles can be efficiently set to be 10 μm or less. Similarly, for example, when the concentration of NaOH in the third aqueous solution is 0.20 mol/L or more (0.23 mol/L or less), the d50 of the NiP particles can be efficiently set to be 7 μm or less. Similarly, for example, when the concentration of NaOH in the third aqueous solution is 0.21 mol/L or more (0.23 mol/L or less), the d50 of the NiP particles can be efficiently set to be 4 μm or less.

The inventor of the present application has been able to know that the sensitivity of d50 of NiP particles to the concentration of NaOH in the third aqueous solution is sufficiently high by an approximation analysis (quadratic approximation formula) based on experiments. For example, as the concentration of NaOH in the third aqueous solution becomes progressively larger, such as 0.19 mol/L, 0.20 mol/L, and 0.21 mol/L, it can be seen that the d50 of the NiP particles becomes correspondingly smaller, such as 10 μm, 7 μm, and 4 μm. That is, it was found that a relatively strong negative correlation exists between the concentration of NaOH in the third aqueous solution and the d50 of NiP particles. Since the sensitivity of d50 of NiP particles to the concentration of NaOH in the third aqueous solution is sufficiently high, the concentration of NaOH (mol/L) in the third aqueous solution should be accurately adjusted to at least the second decimal place and rounded off to the third decimal place. If such a highly sensitive negative correlation between the concentration of NaOH in the third aqueous solution and the d50 of NiP particles is utilized, the minimum value of the concentration of NaOH in the third aqueous solution for achieving the desired d50 of NiP particles can be estimated, so that excessive use of NaOH can be suppressed, and the NiP particles can be reduced in diameter simply and efficiently.

From the above viewpoint, in the invention of the production method, when it is desired to adjust the d50 of the NiP particles to 10 μm or less, for example, the concentration of NaOH in the third aqueous solution is preferably 0.190 mol/L or more and 0.230 mol/L or less. When the concentration of NaOH in the third aqueous solution is 0.190 mol/L or more, the d50 of the obtained NiP particles becomes small, and NiP particles having d50 of 10 μm or less can be efficiently formed. When the concentration of NaOH in the third aqueous solution is less than 0.190 mol/L, the d50 of the NiP particles tends to be larger than 10 μm. Further, when the concentration of NaOH in the third aqueous solution is 0.230 mol/L or less, an effect of reducing the dispersion of the obtained NiP particles to 1.0 or less, for example, can be expected. When the concentration of NaOH in the third aqueous solution exceeds 0.230 mol/L, the tendency for the d50 of the obtained NiP particles to further decrease is weakened.

In the manufacturing method according to the present invention, when the third aqueous solution contains both Cu (Cu ion) and Sn (Sn ion), the molar ratio of Sn to Cu (Sn/Cu) in the third aqueous solution is preferably adjusted to be less than 5.5. When the molar ratio of Sn to Cu (Sn/Cu) in the third aqueous solution is adjusted to less than 5.5 (for example, 1.60 or more and 5.25 or less), the dispersion of the obtained NiP particles tends to become small. Therefore, an effect of efficiently promoting the formation of NiP particles having the dispersion of 1.0 or less can be expected. Incidentally, when the molar ratio of Sn to Cu (Sn/Cu) in the third aqueous solution is adjusted to be excessively large at 5.5 or more, the influence on the reductive deposition reaction is intensified, so that d50 and dispersion of NiP particles may become unstable. For example, when the molar ratio of Sn to Cu (Sn/Cu) in the third aqueous solution is adjusted to 7.5, the reductive deposition reaction becomes unstable, and high-quality NiP particles may not be obtained. From this point of view, the molar ratio of Sn to Cu (Sn/Cu) in the third aqueous solution is preferably adjusted to be reasonably less than 7.7, more preferably less than 5.5.

In the granulation step, the reductive deposition reaction is induced in the third aqueous solution obtained by mixing the first aqueous solution and the second aqueous solution. Therefore, the pH of the third aqueous solution is adjusted to be more than 7 (for example, 8 to 10). When the pH of the third aqueous solution is more than 7 and alkaline, the reductive deposition reaction proceeds rapidly, so that NiP particles can be formed efficiently.

In the granulation step, the liquid temperature of the third aqueous solution may affect the speed of progress of the reductive deposition reaction, d50 of NiP particles, and the like. For example, when it is desired to form NiP particles having d50 of 10 μm or less while rapidly accelerating the reductive deposition reaction, the liquid temperature of the third aqueous solution may be controlled within a range of from 50° C. to 80° C. (preferably from 50° C. to 75° C., more preferably from 50° C. to 70° C.). Further, since the progress of the reductive deposition reaction becomes faster as the liquid temperature of the third aqueous solution becomes higher, when it is desired to further reduce the diameter of the NiP particles (for example, d50 of 7 μm or less), it is preferable to control the liquid temperature of the third aqueous solution in a relatively low temperature range of 55° C. to 65° C. When it is desired to further reduce the diameter (for example, d50 of 5 μm or less), the liquid temperature of the third aqueous solution is preferably controlled in a lower temperature range of 55° C. to 60° C. When the temperature of the third aqueous solution is controlled in a low temperature range (for example, from 55° C. to 65° C.) as described above, an effect of further stabilizing the dispersion of the obtained NiP particles can be expected.

In the present invention, the first aqueous solution contains Ni (Ni ion) and NaOH. The first aqueous solution containing Ni and NaOH can be prepared by mixing an aqueous solution containing Ni and an aqueous solution of NaOH. The concentrations of Ni and NaOH in the first aqueous solution are adjusted with sufficient consideration so that the concentration of NaOH falls within a predetermined range in the third aqueous solution having a pH of more than 7 obtained by mixing the first aqueous solution with the second aqueous solution. The concentrations of Ni and NaOH in the first aqueous solution may be adjusted in consideration of the fact that the concentration of NaOH in the third aqueous solution is preferably within a range of 0.19 mol/L or more (0.23 mol/L or less) when it is desired to select d50 of the NiP particles within a range of 1 μm to 10 μm, for example.

The aqueous solution containing Ni (Ni ion) for constituting the first aqueous solution may be, for example, an aqueous solution of a Ni salt, specifically, an aqueous solution of nickel (II) sulfate hexahydrate, or the like. Examples of the Ni salt include nickel chloride (NiCl₂), nickel sulfide (NiS), nickel sulfate (NiSO₄), nickel nitrate (Ni(NO₃)₂), and nickel carbonate (NiCO₃).

In the present invention, the first aqueous solution preferably contains Cu (Cu ion) in addition to Ni (Ni ion) and NaOH. The first aqueous solution containing Ni, Cu and NaOH can be prepared by mixing an aqueous solution containing Ni, an aqueous solution containing Cu and an aqueous solution of NaOH. The concentrations of Ni, Cu and NaOH in the first aqueous solution are adjusted with sufficient consideration so that the concentration of NaOH falls within a predetermined range in the third aqueous solution having a pH greater than 7 obtained by mixing with the second aqueous solution. The concentrations of Ni, Cu and NaOH in the first aqueous solution may be adjusted in consideration of the fact that the concentration of NaOH in the third aqueous solution is preferably in the range of 0.19 mol/L or more (0.23 mol/L or less) when it is desired to select the d50 of the NiP particles within the range of 1 μm to 10 μm, for example.

The aqueous solution containing Cu (Cu ions) for constituting the first aqueous solution may be, for example, an aqueous solution of a Cu salt, specifically, an aqueous solution of copper (II) sulfate pentahydrate, or the like.

In the present invention, the first aqueous solution preferably contains Cu (Cu ion) in addition to Ni (Ni ion) and NaOH, and more preferably contains Sn (Sn ion). The first aqueous solution containing Ni, Cu, Sn and NaOH can be prepared by mixing an aqueous solution containing Ni, an aqueous solution containing Cu, an aqueous solution containing Sn, and an aqueous solution of NaOH. The concentrations of Ni, Cu, Sn and NaOH in the first aqueous solution are adjusted with sufficient consideration so that the concentration of NaOH falls within a predetermined range in the third aqueous solution obtained by mixing with the second aqueous solution and having a pH of more than 7. The concentrations of Ni, Cu, Sn and NaOH in the first aqueous solution may be adjusted in consideration of the fact that the concentration of NaOH in the third aqueous solution is preferably in the range of 0.19 mol/L or more (0.23 mol/L or less) when it is desired to select d50 of NiP particles in the range of 1 μm to 10 μm, for example.

Here, a ratio (mol/L) of the aqueous solution of NaOH in the third aqueous solution after mixing the first aqueous solution and the second aqueous solution may be calculated, and the concentration of NaOH in the first aqueous solution may be adjusted based on the calculated value. Further, when the first aqueous solution contains Cu, a ratio (mol/L) of the aqueous solution containing Cu in the third aqueous solution or a molar ratio of Ni to Cu (Ni/Cu) in the third aqueous solution may be calculated, and the concentration of Cu in the first aqueous solution may be adjusted based on the calculated value. Further, when the first aqueous solution contains Cu and Sn, a ratio (mol/L) of the aqueous solution containing Cu in the third aqueous solution or a molar ratio of Ni to Cu (Ni/Cu) in the third aqueous solution; and a ratio (mol/L) of the aqueous solution containing Sn in the third aqueous solution or a molar ratio of Ni to Sn (Ni/Sn) in the third aqueous solution may be calculated, and the concentrations of Cu and Sn in the first aqueous solution may be adjusted based on the calculated values. The molar ratio of Ni to Cu (Ni/Cu) and the molar ratio of Ni to Sn (Ni/Sn) can be obtained from the values of the ratio (mol/L) of the aqueous solution containing Ni, the ratio (mol/L) of the aqueous solution containing Cu, and the ratio (mol/L) of the aqueous solution containing Sn in the third aqueous solution. In addition, the molar ratio of Sn to Cu (Sn/Cu) can be obtained by dividing the ratio Sn/Ni by the ratio Cu/Ni.

The aqueous solution containing Sn (Sn ion) for constituting the first aqueous solution may be, for example, an aqueous solution of a tin salt, specifically, an aqueous solution of sodium stannate trihydrate, or the like.

In the present invention, the first aqueous solution may be mixed with, for example, sodium acetate or disodium maleate as a pH buffer. Mixing the pH buffer agent with the first aqueous solution containing NaOH, which is a strong base, an action against a change in pH is generated in the first aqueous solution, which is effective for keeping the pH of the first aqueous solution substantially constant.

In the present invention, the second aqueous solution contains P (hypophosphite ion). The second aqueous solution containing P may be an aqueous solution of a reducing agent such as phosphinic acid (H₃PO₂) containing P, specifically an aqueous solution of sodium phosphinate or the like. The concentration of P in the second aqueous solution is adjusted with sufficient consideration so that the concentration of NaOH falls within a predetermined range in the third aqueous solution having a pH of more than 7 obtained by mixing the second aqueous solution with the first aqueous solution. The concentration of P in the second aqueous solution may be adjusted in consideration of the fact that the concentration of NaOH in the third aqueous solution is preferably in the range of 0.19 mol/L or more (0.23 mol/L or less) when it is desired to select the d50 of the NiP particles within the range of 1 μm to 10 μm, for example.

NiP particles (conductive metal particles) produced by applying the present invention contain at least Ni and P. When the third aqueous solution which induces the reductive deposition reaction contains unavoidable impurities not intended to be contained, the NiP particles contain the unavoidable impurities not intended to be contained. For example, NiP particles contain 1 mass % or more and 15 mass % or less of P with the balance of Ni and unavoidable impurities. In particular, in the case of NiP particles having d50 in the range of 1 μm to 10 μm, it is preferable that the dispersion is 1.0 or less, the content of P is 5% by mass to 15% by mass, and the balance is Ni and unavoidable impurities. The reduction-precipitation type Ni-based NiP particles are excellent in conductivity and can be inexpensively and stably mass-produced. Further, NiP particles containing an appropriate amount of P are superior to Ni particles not containing P in mechanical strength such as hardness.

When the first aqueous solution contains Cu (Cu ions), the NiP particles contain at least Ni, Cu and P. When the third aqueous solution which induces the reductive deposition reaction contains unavoidable impurities not intended to be contained, the NiP particles contain the unavoidable impurities not intended to be contained. For example, the NiP particles include 0.01 mass % or more and 18 mass % or less of Cu and 1 mass % or more and 15 mass % or less of P, with the balance being Ni and unavoidable impurities. In particular, in the case of NiP particles having a d50 in the range of 1 μm to 10 μm, it is preferable that the dispersion is 1.0 or less and NiP particles contain 3.20 mass % to 5.40 mass % of Cu and 5 mass % to 15 mass % of P, with the balance being Ni and unavoidable impurities. NiP particles containing Cu have improved conductivity as compared with NiP particles not containing Cu.

When the first aqueous solution contains Sn (Sn ion), the NiP particles contain at least Ni, Sn and P. When the third aqueous solution which induces the reductive deposition reaction contains unavoidable impurities not intended to be contained, the NiP particles contain the unavoidable impurities not intended to be contained. For example, NiP particles contain more than 0 mass % and 10 mass % or less of Sn and 1 mass % or more and 15 mass % or less of P, with the balance being Ni and unavoidable impurities. In particular, in the case of NiP particles having d50 in the range of 1 μm to 10 μm, it is preferable that the dispersion is 1.0 or less, and the NiP particles contain more than 0 mass % and 1.30 mass % or less of Sn and 5 mass % or more and 15 mass % or less of P, with the balance being Ni and unavoidable impurities.

When the first aqueous solution contains Cu (Cu ion) and Sn (Sn ion), the NiP particles contain at least Ni, Cu, Sn and P. When the third aqueous solution which induces the reductive deposition reaction contains unavoidable impurities not intended to be contained, the NiP particles contain the unavoidable impurities not intended to be contained. For example, NiP particles contain 0.01 mass % or more and 18 mass % or less of Cu, more than 0 mass % and 10 mass % or less of Sn, and 1 mass % or more and 15 mass % or less of P, with the balance being Ni and unavoidable impurities. Particularly, in the case of NiP particles having d50 in the range of 1 μm to 10 μm, it is preferable that the dispersion is 1.0 or less, and the NiP particles contain 3.20 mass % or more and 5.40 mass % or less of Cu, more than 0 mass % and 1.30 mass % or less of Sn, and 5 mass % or more and 15 mass % or less of P, with the balance being Ni and unavoidable impurities.

One or more conductive metal plating layers such as an Au plating layer, a Cu plating layer, a Ni plating layer, or a Pd (palladium) plating layer may be formed on a surface of the NiP particles (conductive metal particles) produced by applying the present invention. Since the conductive metal plating layers made of the materials described above have a higher conductivity than that of the NiP particles, it is advantageous for improving the conductivity and stabilizing the energization when the NiP particles are in contact with each other. In particular, since the Au plating layer is softer than the surface of the NiP particles, it is advantageous for stabilization of the contact state and stabilization of electric current when the NiP particles are in contact with each other.

Here, the application of the conductive metal particles, the required size and the dispersion will be supplemented. The size (e.g., d50) of the conductive metal particles (e.g., NiP particles) is optionally required depending on the application. The d50 value of the NiP particles is required depending on the application, for example, μm or less, 7 μm or less, or 4 μm or less. The NiP particles having d50 of 10 μm or less are widely used for applications such as general flexible printed circuit (FPC). The NiP particles having d50 of 7 μm or less are used for an application such as so-called “Fine Pitch FPC” having a conductive portion with a finer pitch. The d50 of NiP particles used for fine pitch applications is mainly in the range of 3 μm or more and 5 μm or less, but the d50 in the range of 1 μm or more and 4 μm or less is required for the future. Therefore, NiP particles having d50 of 4 μm or less are expected to further contribute to a fine pitch.

Further, for example, when NiP particles having d50 in the range of from 1 μm to 10 μm, d50 in the range of from 1 μm to 7 μm, or d50 in the range of from 1 μm to 4 μm are produced, it is possible to make the dispersion of NiP particles 1.0 or less if this invention is applied. The smaller the dispersion of the NiP particles is, the higher the probability that a stable junction structure is formed by mutual contact of the NiP particles, so that the reliability of electrical connection can be improved. On the other hand, as the dispersion of the NiP particles is larger, the control accuracy of the reductive deposition reaction can be reduced, the number of times of repeating classification can be reduced, and the yield can be improved, so that the production cost can be reduced, so that the NiP particles can easily be supplied inexpensively and stably. Therefore, from the viewpoint of realizing a low-cost and stable supply while improving the reliability of electrical connection, the dispersion of the NiP particles are preferably 0.7 to 1.0, more preferably 0.8 to 1.0, and even more preferably 0.9 to 1.0.

According to the invention of the manufacturing method described above, it is easy to adjust d50 in the cumulative volume distribution curve of the obtained NiP particles to 10 μm or less, and it is easy to adjust the dispersion (d90−d10)/d50 to 1.0 or less. A stable supply of the NiP particles thus obtained to the market can satisfy the needs in various applications such as ACF, ACP, ACAs, FOB and FOF.

Hereinafter, an experiment for confirming the effect of the method for producing the conductive metal particles (NiP particles) according to the present invention and results thereof will be described with reference to the drawings as appropriate.

### <Preparation of Reaction Vessel>

A vessel (reaction vessel) that can withstand a reductive deposition reaction and is provided with a stirring device equipped with rotary blades, a nitrogen gas supply device, and a liquid temperature measuring device is prepared. The reaction vessel is filled with nitrogen gas, and the nitrogen gas is continuously supplied to the reaction vessel so that the invasion of the atmosphere into the reaction vessel is suppressed and the discharge of the product gas produced by the reductive deposition reaction is promoted. The supply of the nitrogen gas is continued while the amount (flow rate) of nitrogen gas is controlled in a timely manner until the production of the NiP particles is completed.

### <Preparation of First Aqueous Solution>

Pure water is put into the reaction vessel, and sodium hydroxide (NaOH) is added to the reaction vessel while stirring with a rotary blade. This stirring is continued while controlling the rotational speed of the impeller until the production of the NiP particles is completed. Then, nickel (II) sulfate hexahydrate as a source of Ni (Ni ion) is added to the reaction vessel. If necessary, copper (II) sulfate pentahydrate serving as a Cu (Cu ion) source, sodium acetate serving as a pH buffer agent, and sodium stannate trihydrate serving as a Sn (Sn ion) source can be added to the reaction vessel. The mixing ratio of the individual substances constituting the first aqueous solution and the second aqueous solution are calculated accurately, and the concentration of NaOH in the first aqueous solution is adjusted so that the concentration of NaOH in the third aqueous solution became a specific concentration value corresponding to a desired d50 when the third aqueous solution was obtained by mixing the first aqueous solution and the second aqueous solution. Thus, a first aqueous solution is obtained.

### <Preparation of Second Aqueous Solution>

A container different from the reaction vessel is prepared and pure water is poured in the container. Sodium phosphinate monohydrate as a source of P (hypophosphite ion) is added to the container. The mixing ratio of the individual substances constituting the second aqueous solution is calculated accurately in sufficient consideration of the blending ratio of the individual substances constituting the first aqueous solution so that the concentration of NaOH in the third aqueous solution becomes a specific concentration value corresponding to a desired d50 when the third aqueous solution is obtained by mixing the first aqueous solution and the second aqueous solution, and the second aqueous solution is prepared. Thus, the second aqueous solution is obtained.

### <Third Aqueous Solution>

A first aqueous solution containing Ni (Ni ion) and NaOH is heated using an external heater. The liquid temperature of the first aqueous solution is controlled at a temperature (reaction temperature) at which the reductive deposition reaction occurs. The first aqueous solution contains Cu (Cu ion) if necessary, and further contains Sn (Sn ion) if necessary. Further, a second aqueous solution containing P (hypophosphite ion) is heated using an external heater. Similarly, the liquid temperature of the second aqueous solution is controlled at a temperature (reaction temperature) at which the reductive deposition reaction occurs. Next, the second aqueous solution is added to the reaction vessel containing the first aqueous solution, and stirred and mixed to obtain a mixed aqueous solution. Thus, a mixed aqueous solution of the first aqueous solution and the second aqueous solution, i.e., a third aqueous solution is obtained. The pH of the third aqueous solution becomes more than 7 due to NaOH contained in the first aqueous solution, and the concentration of NaOH becomes a specific concentration value due to the fact that NaOH is adjusted to a specific concentration value in the first aqueous solution. The temperature of the third aqueous solution is continuously controlled to the reaction temperature by using an external heater until the production of NiP particles is completed.

### <Formation of NiP Particles>

In the third aqueous solution obtained by the above-described procedure and controlled at the reaction temperature, sodium phosphinate monohydrate contained in the second aqueous solution serves as a reducing agent to cause a reductive deposition reaction. Aa large number of Ni-based metal nuclei are produced by the reductive deposition reaction induced in the third aqueous solution, and eventually grow into a large number of NiP particles. At this time, NiP particles having a specific d50 can be formed smoothly and stably in accordance with the concentration value of NaOH in the third aqueous solution.

Based on the above procedure, a third aqueous solution was prepared under the conditions shown in Table 1, and each experiment was carried out. At this time, the third aqueous solution immediately after the first aqueous solution and the second aqueous solution were mixed (at the start of reductive deposition) was alkaline, and its pH was, for example, 7.6 for No. 2; 8.9 for No. 3; 9.1 for No. 4; 8.9 for No. 8; 9.3 for No. 9; and 8.1 for No. 12. As a result of each experiment, NiP particles shown in Table 2 were obtained. FIG. 5 is a typical observation image (photograph) of the obtained NiP particles, which are NiP particles of No. 3 (d50: 1.13 μm, dispersion: 0.91, P: 10.05 mass %, Cu: 4.04 mass %, Sn: 0.97 mass %, and the balance is less than 0.01 mass %). The d50 and the dispersion of the NiP particles shown in Table 1 were obtained from a cumulative volume distribution curve obtained by a measuring apparatus employing a laser diffraction scattering method. The chemical composition (mass %) of the NiP particles shown in Table 2 is determined by Inductively Coupled Plasma (ICP) analysis using a solution prepared by dissolving a certain amount (0.1 g) of NiP particles in aqua regia.

TABLE 1

| | NaOH | Liquid | Ni/Cu | Ni/Sn | Sn/Cu |
|---|---|---|---|---|---|
| Experimental | concentration | temperature | (molar | (molar | (molar |
| Run No. | (mol/L) | (° C.) | ratio) | ratio) | ratio) |
| 1 | 0.190 | 68 | 24.0 | 0.0 | — |
| 2 | 0.207 | 68 | 24.0 | 0.0 | — |
| 3 | 0.228 | 60 | 24.0 | 4.8 | 5.0 |
| 4 | 0.228 | 60 | 24.0 | 4.4 | 5.5 |
| 5 | 0.228 | 60 | 24.0 | 0.0 | — |
| 6 | 0.228 | 60 | 24.0 | 9.6 | 2.5 |
| 7 | 0.228 | 60 | 24.0 | 6.4 | 3.8 |
| 8 | 0.228 | 60 | 19.0 | 4.8 | 4.0 |
| 9 | 0.228 | 60 | 32.0 | 4.8 | 6.7 |
| 10 | 0.233 | 60 | 24.0 | 4.8 | 5.0 |
| 11 | 0.214 | 68 | 24.0 | 4.8 | 5.0 |
| 12 | 0.212 | 68 | 24.0 | 4.8 | 5.0 |
| 13 | 0.218 | 68 | 24.0 | 4.8 | 5.0 |
| 12 | 0.218 | 68 | 24.0 | 4.8 | 5.0 |
| 15 | 0.218 | 60 | 24.0 | 4.8 | 5.0 |
| 16 | 0.218 | 60 | 24.0 | 4.8 | 5.0 |
| 17 | 0.218 | 55 | 24.0 | 4.8 | 5.0 |
| 18 | 0.220 | 55 | 24.0 | 4.8 | 5.0 |

[Note]
Nos. 1, 2 and 5 do not contain Sn.

TABLE 2

| Experimental | d50 | | Chemical component (mass %) | | | | | Sn/Cu |
|---|---|---|---|---|---|---|---|---|
| Run No. | (μm) | Sparsity | Ni | P | Cu | Sn | Others | (mass ratio) |
| 1 | 9.30 | 0.64 | Balance | 6.98 | 3.35 | 0.00 | <0.01 | — |
| 2 | 7.02 | 0.63 | Balance | 7.15 | 3.28 | 0.00 | <0.01 | — |
| 3 | 1.13 | 0.91 | Balance | 10.50 | 4.04 | 0.97 | <0.01 | 0.24 |
| 4 | 0.98 | 1.80 | Balance | 11.10 | 4.13 | 1.34 | <0.01 | 0.32 |
| 5 | 4.91 | 0.61 | Balance | 7.13 | 4.03 | 0.00 | <0.01 | — |
| 6 | 1.70 | 0.76 | Balance | 7.21 | 4.14 | 0.53 | <0.01 | 0.13 |
| 7 | 2.42 | 0.70 | Balance | 8.46 | 3.96 | 0.50 | <0.01 | 0.13 |
| 8 | 1.28 | 0.81 | Balance | 9.92 | 4.66 | 0.98 | <0.01 | 0.21 |
| 9 | 0.96 | 1.24 | Balance | — | — | — | — | — |
| 10 | 1.04 | 0.96 | Balance | — | — | — | — | — |
| 11 | 2.68 | 0.70 | Balance | 10.20 | 3.78 | 0.57 | <0.01 | 0.15 |
| 12 | 3.63 | 0.64 | Balance | — | — | — | — | — |
| 13 | 1.81 | 0.74 | Balance | 10.70 | 3.79 | 0.78 | <0.01 | 0.21 |
| 12 | 1.92 | 0.77 | Balance | 10.60 | 3.91 | 0.73 | <0.01 | 0.19 |
| 15 | 1.85 | 0.66 | Balance | 10.50 | 4.05 | 0.70 | <0.01 | 0.17 |
| 16 | 1.93 | 0.66 | Balance | — | — | — | — | — |
| 17 | 1.85 | 0.69 | Balance | 9.71 | 3.86 | 0.60 | <0.01 | 0.16 |
| 18 | 1.73 | 0.70 | Balance | 9.72 | 4.01 | 0.76 | <0.01 | 0.19 |

[Note]
Nos. 1, 2 and 5 do not contain Sn.

The chemical compositions of No. 9, 10, 12, 16 were not analyzed.

<Relationship Between Concentration of NaOH and d50>

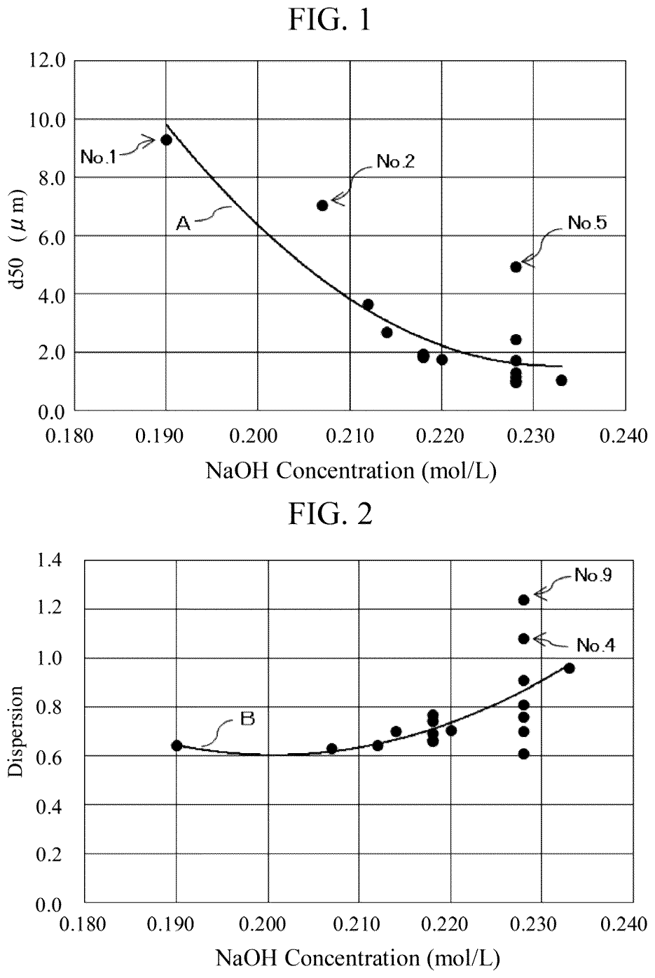

The graph shown in FIG. 1 shows the relationship between the concentration (mol/L) of NaOH in the third aqueous solution shown in Table 1 and the d50 of NiP particles shown in Table 2. A curve (A) shown in FIG. 1 is a quadratic trendline (Y=4655X²−2162X+252.6, where X is the concentration of NaOH and Y is d50) obtained from all the data shown in FIG. 1, that is, from plural experimental results shown in Table 2 corresponding to a plurality of experimental conditions shown in Table 1. Curve (A) based on the plural experiments shows a strong negative correlation that the higher the concentration of NaOH in the third aqueous solution which induces the reductive deposition reaction, the smaller the d50 of the obtained NiP particles. Using this curve (A), the d50 of the NiP particles obtained by the concentration of NaOH in the third aqueous solution can be accurately predicted and adjusted. By adjusting the concentration of NaOH in the third aqueous solution in consideration of this prediction result, the d50 of the obtained NiP particles can be accurately regulated. That is, the concentration of NaOH in the third aqueous solution is adjusted so that the median diameter of the conductive metal particles is regulated to 10 μm or less.

Specifically, when the concentration of NaOH in the third aqueous solution is 0.190 mol/L, for example, it can be predicted from the curve (A) that the d50 of the obtained NiP particles becomes about 9.9 μm. Similarly, when the concentration of NaOH is 0.200 mol/L, 0.210 mol/L, 0.220 mol/L and 0.230 mol/L, it can be expected that the d50 of the resulting NiP particles will be about 6.4 μm, about 3.9 μm, about 2.3 μm and about 1.6 μm, respectively. Further, referring to curve (A), it can be easily predicted that the d50 of the obtained NiP particles becomes about 14.3 μm when the concentration of NaOH in the third aqueous solution is 0.180 mol/L, so that the risk can be known in advance that the d50 rapidly increases beyond 10 μm when the concentration of NaOH is reduced. Further, according to the curve (A), it can be predicted that the d50 of the obtained NiP particles becomes 1.59 when the concentration of NaOH in the third aqueous solution is 0.230 mol/L, and the d50 of the obtained NiP particles becomes about 1.8 μm when the concentration of NaOH is 0.240 mol/L. In other words, it can be known in advance that the effect of reducing d50 is weakened even if the concentration of NaOH is further increased.

<Relationship Between Sn Content and d50>

Here, it is understood from the graph shown in FIG. 1 that No. 1, No. 2 and No. 5, which do not contain Sn (Sn ion) in the third aqueous solution, are positioned clearly on the upper side (+ side) with respect to the curve (A) as the concentration of NaOH in the third aqueous solution increases. Thus, it can be known in advance that the obtained NiP particles tend to have a larger d50. In addition, it can be seen that No. 2 and No. 5 have smaller d50 than that of No. 1, but they are greatly separated from the curve (A) to the upper side (+ side). Therefore, it can be known in advance that the third aqueous solution for causing the reductive deposition reaction preferably contains an appropriate amount of Sn (Sn ion) when it is desired to make the d50 of the NiP particles smaller.

### <Relationship Between Concentration of NaOH and Dispersion>

The graph shown in FIG. 2 shows the relationship between the concentration (mol/L) of NaOH in the third aqueous solution shown in Table 1 and the dispersion of NiP particles shown in Table 2. A curve (B) shown in the FIG. 2 is a quadratic trendline (Y=354X²−142.1X+14.86, where “X” is the concentration of NaOH and “Y” is the dispersion) obtained from all the data shown in the FIG. 2, that is, from a plurality of experimental results shown in Table 2 corresponding to a plurality of experimental conditions shown in Table 1. Curve (B) based on this plurality of experiments shows a positive and relatively strong correlation that the higher the concentration of NaOH in the third aqueous solution which induces the reductive deposition reaction, the greater the dispersion of the obtained NiP particles. Using this curve (B), the dispersion of the NiP particles obtained by the concentration of NaOH in the third aqueous solution can be accurately predicted. By adjusting the concentration of NaOH in the third aqueous solution in consideration of this prediction result, the dispersion of the obtained NiP particles can be accurately regulated. That is, the concentration of NaOH in the third aqueous solution is adjusted so that the dispersion of the conductive metal particles is 1.0 or less.

Specifically, when the concentration of NaOH in the third aqueous solution is, for example, 0.190 mol/L, it can be predicted from the curve (B) that the dispersion of the obtained NiP particles becomes about 0.64. Similarly, when the concentration of NaOH was 0.200 mol/L, 0.210 mol/L, 0.220 mol/L or 0.230 mol/L, it can be expected that the resulting dispersion of NiP particles would be about 0.60, about 0.63, about 0.73 or about 0.90, respectively. Further, when the concentration of NaOH in the third aqueous solution is 0.180 mol/L, it can be predicted that the dispersion of the obtained NiP particles becomes about 0.75. In other words, referring to the curve (B), it can be known in advance that the dispersion is suppressed when the concentration of NaOH is increased from 0.180 mol/L, but the effect of suppressing the dispersion is weakened when the concentration of NaOH is further increased above a certain level. Further, when the concentration of NaOH in the third aqueous solution is 0.240 mol/L, it can be predicted that the dispersion of NiP particles obtained will be about 1.15, so that the risk that the dispersion will rapidly increase beyond 1.0 can be known in advance.

### <Relationship Between Molar Ratio of Sn to Cu (Sn/Cu) and Dispersion>

Here, it can be seen from the graph shown in FIG. 2 that No. 4 and No. 9, in which the molar ratio of Sn to Cu (Sn/Cu) of the third aqueous solution is large, are positioned clearly on the upper side (+ side) with respect to the curve (B). Thus, it is possible to know in advance that the dispersion of the obtained NiP particles tends to increase. In addition, it can be known that No. 9 is farther away from the curve (B) to the upper side (+ side) than No. 4 since No. 9 has a higher dispersion than No. 4. Therefore, it can be known in advance that it is preferable to appropriately adjust the molar ratio of Sn to Cu (Sn/Cu) of the third aqueous solution which induces the reductive deposition reaction when it is desired to make the dispersion of the NiP particles smaller.

### INDUSTRIAL APPLICABILITY

The present invention can be applied as a method for producing conductive metal particles (NiP particles) especially for applications requiring a small diameter (for example, d50 of 1 μm to 10 μm), for example, as a method for producing conductive metal particles (NiP particles) for forming an anisotropic conductive film, an anisotropic conductive sheet, an anisotropic conductive adhesive, an anisotropic conductive paste, or the like.

This application is based on Japanese Patent Application No. 2021-056511 filed on Mar. 30, 2021, the contents of which are incorporated herein by reference.

### REFERENCE SIGNS LIST

A Curve (quadratic trendline)
B Curve (quadratic trendline)

1. A method for producing conductive metal particles, the method comprising:
mixing a first aqueous solution containing Ni and NaOH with a second aqueous solution containing P to prepare a third aqueous solution with a pH greater than 7; and
inducing a reductive deposition reaction in the third aqueous solution to produce Ni-based conductive metal materials, wherein
a median diameter of the conductive metal particles is regulated by adjusting the concentration of NaOH in the third aqueous solution,
wherein the concentration of NaOH in the third aqueous solution is adjusted to 0.190 mol/L or more and 0.230 mol/L or less.

2. The method for producing conductive metal particles according to claim 1, wherein the concentration of NaOH in the third aqueous solution is adjusted so that the median diameter of the conductive metal particles is regulated to 10 μm or less.

3. The method for producing conductive metal particles according to claim 1, wherein the concentration of NaOH in the third aqueous solution is adjusted so that the dispersion of the conductive metal particles is adjusted to 1.0 or less.

4. (canceled)

5. The method for producing conductive metal particles according to claim 1, wherein the first aqueous solution further contains Cu.

6. The method for producing conductive metal particles according to claim 1, wherein the first aqueous solution further contains Sn.

7. The method for producing conductive metal particles according to claim 6, wherein the first aqueous solution further contains Cu, and
a molar ratio of Sn to Cu (Sn/Cu) in the third aqueous solution is adjusted to be less than 5.5.
